(19) United States
(12) Patent Application Publication
(10) Pub. No.: US 2025/0243113 A1
(43) Pub. Date: Jul. 31, 2025

(54) Redundant tires in concrete mix and concrete products

(71) Applicant: Wasif Afzal Ahmad RIZVI, Mumbai (IN)

(72) Inventor: Wasif Afzal Ahmad RIZVI, Mumbai (IN)

(21) Appl. No.: 18/857,448

(22) PCT Filed: May 19, 2023
(86) PCT No.: PCT/IB2023/055145

§ 371 Date: Oct. 16, 2024

(30) Foreign Application Priority Data
May 21, 2022 (IN) 202221029359

(51) Int. Cl. C04B 18/22; C04B 14/06; C04B 28/08

(52) U.S. Cl. CPC C04B 18/22; C04B 14/062; C04B 28/08; C04B 2201/50

(57) ABSTRACT

A concrete product having redundant tires and concrete mix is disclosed. The concrete product comprises a dry mix concrete, and redundant tires. The redundant tires include fine particles or small pieces of waste rubber or tires. The redundant tires are shredded to pass 2 millimetre sieve. The weight of the redundant tires is selected to be about two percent of the weight of the dry mix concrete. The redundant tire particles (passing 2 mm sieve) and the dry mix concrete are mixed, casted and cured for a predefined time period for obtaining a concrete block of a predefined compressive strength. The concrete product is used for making building, roadways, or constructional elements such as concrete masonry unit blocks, autoclaved aerated concrete blocks, cast-in-situ, precast concrete, Oregon barriers, Sandcrete, concrete tetrapods, composite asphalt, curb stones, interlocking tiles. The construction material helps in significant environmental benefits resulting from removing waste rubber while utilizing the waste rubber beneficially.

### FIELD OF DISCLOSURE

The present invention relates to construction material. More specifically, the present disclosure relates to a construction material i.e., a concrete product having redundant tires and a concrete mix.

### BACKGROUND OF DISCLOSURE

With exponential growth in vehicles used for transport, more tires made of rubber are manufactured and used. Once the life of tires ends, the tires are disposed of. It is estimated that 2.5 billion new tires are manufactured annually and 700 million tires are disposed annually. Improper disposal of the tires causes serious pollution problems. Specifically, it is difficult to dispose of the tires due to the physicochemical properties that the tires acquire when subjected to vulcanization, so their elimination is extremely complicated. For countries like India, the tires that are not in use usually end up in the streets, vacant lots, open-air dumps and in few cases in landfills. These deposits quickly become a health hazard for the people living nearby areas as they may lead to non-native mosquito breeds, potential for fires or emission of greenhouse gases, if left in the open dump yards.

According to data from environmental organizations and related organizations, currently the recycling rate of waste tires is about 77.1% in the year 2020 and 58.8% in the year 2021. The data indicates that it is necessary to increase the actual recycling rate such as processing and use, and to develop environmentally friendly functional products through mixing with other environmental wastes during processing and use.

One of the methods for recycling the waste tires is a product manufacturing method. In the product manufacturing of waste tires, waste tires are collected, crushed, pulverized, and sorted, and then the produced powder is subjected to a predetermined coloring process with bonding agents. It is common to mix a base binder or a binder required according to the characteristics of the product. This manufacturing method is the only mechanical method of the product manufacturing method using rubber chips of waste tires. However, the manufacturing method is not sufficient to make high stability products. In addition, the bonding agents are generally relatively expensive adhesive or latex compounds. The production costs of the resulting products are inevitably very high.

Some methods have been disclosed in the past. One such method is disclosed in a Chinese Patent Application No. 113929357, entitled “Asphalt road mixture and construction method”. CN113929357A discloses an asphalt road mixture which comprises, by weight, 60-100 parts of waste asphalt, 20-30 parts of waste tires, 30-50 parts of tailings, 10-25 parts of diatomite, 5-15 parts of heavy calcium powder, 10-20 parts of clay, 5-15 parts of shells, 10-15 parts of a viscous component, 20-40 parts of a fiber component, 5-10 parts of resin, 40-60 parts of building waste and 100-200 parts of water; the construction method comprises the steps of selecting pavers to pave the asphalt mixture, and grinding the paved asphalt mixture by closely following a steel wheel road roller and a rubber wheel road roller behind each paver. The asphalt road mixture provided by the invention has excellent anti-cracking capability, water retention performance and pressure resistance, and a large amount of waste materials are adopted, so that the production cost is reduced, and the laying quality of the asphalt mixture can be improved by the provided construction method.

Another example is disclosed in a PCT Publication No 2021227685, entitled “Impermeable concrete having polypropylene fiber and waste tire rubber particles added, and preparation method therefor”. WO2021227685A1 discloses an impermeable concrete having polypropylene fiber and waste tire rubber particles added, and a preparation method therefor. A raw material comprises rubber particles, a polypropylene fiber, a cement, water, sand, rubbles, and a water reducing agent. The preparation method comprises: putting the rubber particles into an alkaline solution for immersing for 30 minutes, taking out, washing with clean water, airing and drying; pouring the cement into water, and fully stirring with a cement stirrer; uniformly mixing the polypropylene fiber with the rubber particles, and then pouring the mixture into a pre-stirred cement, adding the water reducing agent, and fully stirring with the cement stirrer; and pouring the rubbles and sand into the cement, and fully stirring to obtain an impermeable concrete.

Considering the problems discussed above, there is a need in the art to provide an improved construction material utilizing scrap rubber (waste or unused rubber or redundant shredded tire rubber) in construction of buildings, roadways (composite asphalt and Pavement quality concrete roads), concrete masonry unit blocks, concrete mix (i.e., up to C/M-40 MPA), jersey barriers, concrete tetrapod, light weight concrete, landscaping (curbstones and interlocking tiles) etc.

### SUMMARY OF THE INVENTION

It is an object of the present invention to provide a concrete product having redundant tires and concrete mix and that avoids the drawback of known techniques.

It is another object of the present invention to provide a concrete product having shredded tire fiber less than <2.04% by dry mix weight (i.e., up to 48 kg/m³ of concrete) passing 2 mm sieve.

In order to achieve one or more objects, the present subject matter provides a concrete product having redundant tires and concrete mix. The concrete product comprises a dry mix concrete, and redundant tires. The redundant tires include fine particles or small pieces of waste rubber or tires. The redundant tires are shredded to pass 2 millimeter (mm) sieve. The weight of the redundant tires is selected to be about two percent of the weight of the dry mix concrete. The redundant tires and the dry mix concrete are mixed, casted and cured for a predefined time period for obtaining a concrete block of a predefined compressive strength.

In one technical advantageous feature, the present invention provides compression strength of 38.014 MPA or N/mm2 after 28 days of curing with a tolerance of +/−10% of compressive strength of C/M 40 MPA or N/mm2.

In another technical advantageous feature, the present invention provides compression strength of 26.029 MPA or N/mm2 after 9 days of curing of a cube mix.

In one advantageous feature of the present invention, the redundant tires can be used in concrete mix up to grade C/M 40 MPA or N/mm2 and concrete products such as jersey/Oregon barriers, curbstones, interlocking tiles, Concrete block masonry units, AAC (autoclaved aerated concrete blocks), Concrete tetrapods, precast/cast in situ concrete, backfilling sandcrete, composite asphalt/concrete roads etc.

Features and advantages of the subject matter hereof will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

The novel features which are believed to be characteristic of the process and end products according to the present invention, as to their structure, organization, use and method of operation, together with further objectives and advantages thereof, will be better understood from the following drawings in which a presently preferred process according to the invention will now be illustrated by way of example. It is expressly understood, however, that the drawings are for the purpose of illustration and description only, and are not intended as a definition of the limits of the invention. In the accompanying drawings:

FIG. 1 illustrates a composite road construction that depicts rubber chips/particles (passing 2 mm sieve) used in pavement quality concrete (PQC), in accordance with one exemplary embodiment of the present disclosure.

### DETAILED DESCRIPTION

The following detailed description is susceptible to various modifications and alternative forms, specific embodiments thereof will be described in detail and shown by way of example. It should be understood, however, that there is no intent to limit example embodiments of the present disclosure to the particular forms disclosed. Conversely, example embodiments are to cover all modifications, equivalents, and alternatives falling within the scope of the disclosure.

The terminology used herein is for the purpose of describing particular embodiments only and is not intended to limit the disclosure. As used herein, the singular forms “a,” “an,” and “the” are intended to include the plural forms as well, unless the context clearly indicates otherwise. It should be further understood that the terms “comprises,” “comprising,” “includes,” “including,” and/or “having” specify the presence of stated features, integers, steps, operations, elements, and/or components when used herein, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present disclosure belongs. It should be further understood that terms, e.g., those defined in commonly used dictionaries, should be interpreted as having a meaning that is consistent with their meaning in the context of the relevant art and are not to be interpreted in an idealized or overly formal sense unless expressly so defined herein.

The present disclosure discloses construction material utilizing waste material such as discarded rubber (from vehicle tires) for use in construction of buildings, roadways, or constructional elements such as CMU (concrete masonry unit blocks), AAC (autoclaved aerated concrete blocks), Interlock tiles, Curbstones, Cast-in-situ/precast concrete, New Jersey barriers, Oregon barriers, Concrete tetrapod, and other allied concrete products, Backfilling sandcrete, Composite asphalt and concrete roads etc.

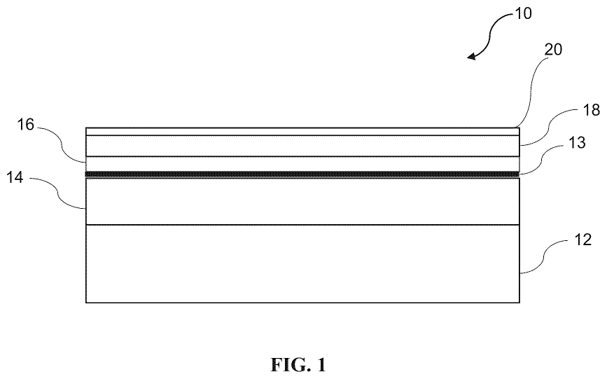

FIG. 1 shows a composite road construction that depicts rubber chips/particles (passing 2 mm sieve) in pavement quality concrete (PQC), in accordance with one exemplary embodiment of the present disclosure. A composite road 10 includes a first layer 12, a second layer 14, a third layer 16, a fourth layer 18, and a fifth layer 20. The first layer 12 indicates a compacted earth layer, where the soil particles are compressed. In one example, the depth of the first layer 12 is about 60 cm. The second layer 14 indicates a road base. The road base is a layer of gravel/crushed rock in a road pavement. In one example, the depth of the first layer 12 is about 60 cm. The second layer 14 includes well compacted soil i.e., 95% compacted soil. The third layer 16 includes dry lean concrete mixture. The dry lean concrete is a mixture in which the amount of cement is less than the amount of liquid that is present in the layers. In one example, the depth of the third layer 16 is about 10 cm.

In one embodiment, a polyethylene sheet 13 is placed between the third layer 16 and the first layer 12. The polyethylene sheet 13 acts as a drainage layer. The thickness of the polyethylene sheet is about 200 microns, for example. The fourth layer 18 includes a pavement quality concrete (PQC) mixture. Further, the fourth layer 18 includes rubber chips. For environmental protection, it is preferable to use discarded rubber, e.g., rubber chips from waste tire rubber. In one example, fine rubber is used. In another example, rubber is chipped using known methods into small pieces having size about 3 mm to 20 mm. In another example, the rubber is chipped to have size about 2 mm. It is possible to shred the rubber pieces of varying size depending on the need. A mixture is prepared by using 100 kg rubber chips with pavement quality concrete. In one example 50 to 100 kilograms of rubber chips are mixed with 1 cubic meter of concrete for construction of roads or repairing roads.

Further, the mixture is distributed over the third layer 16 to form the fourth layer 18. A person skilled in the art understands that the weight of the rubber chips with PQC can vary depending on the need. The depth of the fourth layer 18 is about 20 cm. The fifth layer 20 indicates a wearing course. The fifth layer 20 is the upper layer that includes asphalt. The depth of the fifth layer 20 is about 5 cm. A tack coat is applied between fourth layer 18 and fifth layer 20. The tack coat is a sprayed application of an asphalt binder upon an existing asphalt or between layers of new asphalt concrete.

The presently disclosed constructional material utilizing a mixture of rubber waste with concrete can be used for the repair of highway surfaces. A person skilled in the art understands that the constructional material can be used for the repair of virtually any other surface such as runways, taxiways, parking lots, pathways and the like without departing from the scope of the present disclosure.

In accordance with the embodiments of the present invention, a best mode of working the invention is described below. In one example, a test of dry mix concrete of C40/M40 grade with addition of tire fiber passing 4.75 millimeter (mm) sieve and 2 mm sieve were conducted. For explaining the working of the invention, only the tire fiber passing 2 mm sieve is considered. Here, the dry mix consisting of cement, fine aggregates, coarse aggregates, crushed sand and air classified sand are considered. The cement content comprises Ordinary Portland Cement (OPC), Ground Granulated Blast Furnace Slag (GGBS), pulverized fuel ash (or fly ash) and micro silica. In one example, a total of 470 kilograms (kgs) of cement i.e., 225 kgs of OPC, 207 Kgs of GGBS, 18 kgs of fly ash and 20 kgs of micro silica were considered. Further, 460 kgs of fine aggregates such as natural sand or crushed stone having size less than 10 mm are considered. Further, 515 kgs of coarse aggregates such as sand, gravel, or crushed stone. As known, the fine aggregates include particles that pass through 4.75 mm sieve and retain on 0.075 sieve. The coarse aggregates include particles that retain on 4.75 mm sieve. Further, 805 kgs of crushed sand is considered. In addition, 100 kgs of air classified sand is considered. The total weight of dry mix concrete consisting of cement, fine aggregates, coarse aggregates, crushed sand and air classified sand is 2350 kgs/m³.

As specified above, the dry mix concrete is mixed with tire fiber (tire grain, shredded tire) passing 2 mm sieve. Particularly, the weight of tire fiber is selected as up to 2 percent (%) of the dry mix concrete. In the present example, the weight of tire fiber is selected as less then 2.04 percent (%) of the dry mix concrete the quantity of water used to mix the tire fiber and dry mix concrete is 210 liter/m3, and the admixture is 5.4 liter/m3. The dry mix concrete and the tire fiber were mixed in concrete mixer and cube samples were casted.

At first, the cubes are cured for a period of nine (9) days. Subsequently, the cubes are tested with a compression machine having weight of approximately 8000-8500 grams with a size of 150*150*150 mm with a cross-sectional area of 22500 mm². The cubes can undergo a load of 550-650 KN and show an average compression strength of 26.029 N/mm².

In another example, the concrete mix/construction material cubes are cured for a period of twenty-eight (28) days. The cubes are tested with a compression machine having weight of approximately 8000-8500 grams with a size of 150*150*150 mm with a cross-sectional area of 22500 mm². The cubes can undergo a load of 550-670 KN and show an average compression strength of 38.0214 N/mm².

With multiple tests, the construction material shows an average compression strength of 38.0214 N/mm² with a tolerance of +/−10 percent (%) compression strength (of C/M 40 MPA or N/mm²) with varied loads, after 28 days of curing. Further, the results show that shredded tire fiber passing 2 mm sieve, up to 2.04% weight per m³ of concrete (i.e., 48 kgs per 2350 Kg/m³) or 48 kgs in 470 kgs cement content, which is 10.2 percent of cement content.

Optionally, tire particles (pulverized tire rubber) passing one (1) mm sieve having up to 3 percent of dry mix concrete weight can be used to achieve similar compression strength for the concrete cubes.

In some instances, the test for construction material with a dry mix concrete with tire fiber passing 4.75 mm sieve may fail the test (breaking of the cubes).

The presently disclosed construction material provides several advantages over prior art. The construction material includes shredded tire fiber less than <2.04% by dry mix weight (i.e., up to 48 kg/m³ of concrete) passing 2 mm sieve. This allows the redundant tires to be mixed with concrete mix up to grade C/M 40 for use in jersey barriers, Oregon barriers, curbstones, interlocking tiles, Concrete block masonry units, Concrete tetra pods, cast in-situ structural concrete, composite asphalt and concrete roads, backfilling sandcrete, screed, precast concrete, AAC (autoclaved aerated concrete blocks) etc.

Typically, manufacturing of one concrete masonry unit partition (a block) weighing 35 Kilograms (kgs)/unit requires 1:6 (1-part cement:6-parts sand). A person skilled in the art understands that 68 blocks constitute one cubic meter. By utilizing the presently disclosed constructional material, it is possible to rearrange the mixture to 1:1:5 (1-part cement:1-part rubber chips:5-parts crushed sand). This allows almost 60 kgs of rubber chips to be added to 1 cubic meter of blocks. Utilizing rubber pulverized rubber passing 2 mm sieve reduces the cost of the block for each cubic meter.

Furthermore, for composite asphalt and concrete roads, conventional products utilize cracked automobile windshields owing to conventional rock aggregates used in road constructions, in case of road disintegration. This increases insurance costs for the vehicles. Utilizing the presently disclosed constructional material, it is possible to reduce cracked windscreen leading to saving in car insurance premiums and reduce cost of road as rubber particles passing 2 mm sieve replace conventional fine aggregates in a limited proportion.

Based on the above, it is evident that the presently disclosed constructional material allows to utilize the waste material i.e., used rubber and repurpose/reuse it for use in construction of a variety of products. Pulverized redundant tire rubber (passing 2 mm sieve) lowers the cost of construction while ensuring the efficiency of construction. Pulverized redundant tire rubber provides significant environmental benefits resulting from removing waste rubber from the environment while utilizing such waste rubber beneficially. The shredding/pulverization of rubber through mechanical shredders does not require use of chemicals further benefitting the environment. In other words, the presently disclosed tire recycling mechanism creates a positive impact on the environment and develops reliable and cost-effective substitutes for construction raw materials.

The present disclosure has been described in particular detail with respect to various possible embodiments, and those of skill in the art will appreciate that the disclosure may be practiced in other embodiments. First, the particular naming of the components, capitalization of terms, or structural aspect is not mandatory or significant, and the mechanisms that implement the disclosure or its features may have different names, formats, or protocols.

It should be understood that components shown in FIG. 1 are provided for illustrative purposes only and should not be construed in a limited sense. A person skilled in the art will appreciate alternate components that may be used to implement the embodiments of the present disclosure and such implementations will be within the scope of the present disclosure.

While preferred embodiments have been described above and illustrated in the accompanying drawings, it will be evident to those skilled in the art that modifications may be made without departing from this disclosure. Such modifications are considered as possible variants included in the scope of the disclosure.

What is claimed is:

1. A method of mixing redundant tires in concrete mix, the method comprising the steps of:
providing a dry mix concrete;
shredding redundant tires;
adding the redundant tires to the dry mix concrete;
casting a mix of the redundant tires and the dry mix concrete; and
curing the mix for a predefined time period for obtaining a concrete block of a predefined compressive strength,
characterised in that:
the redundant tires being shredded to pass 2 millimetre sieve, and the weight of the redundant tires being about two percent of the weight of the dry mix concrete.

2. The method as claimed in claim 1, comprising adding water and admixture to the redundant tires and the dry mix concrete.

3. The method as claimed in claim 1, comprising curing the mix for a period of nine or twenty-eight days.

4. The method as claimed in claim 1, the mix being cured to obtain the predefined compressive strength of 40 Mega Pascal (Mpa).

5. The method as claimed in claim 1, the dry mix concrete containing ordinary portland cement (OPC), ground granulated blastfurnace slag (GGBS), pulverised fuel ash micro silica, fine aggregates, coarse aggregates, crushed sand and air classified sand.

6. A concrete product having redundant tires and concrete mix, the concrete product comprising:
a dry mix concrete; and
redundant tires, wherein the redundant tires are shredded and added with the dry mix concrete,
characterised in that:
wherein the redundant tires are shredded to pass 2 millimetre sieve, and the weight of the redundant tires is about two percent of the weight of the dry mix concrete, and
wherein the redundant tires and the dry mix concrete are mixed, casted and cured for a predefined time period for obtaining a concrete block of a predefined compressive strength.

7. The concrete product as claimed in claim 6, wherein the dry mix concrete comprises ordinary portland cement (OPC), ground granulated blast furnace slag (GGBS), pulverised fuel ash micro silica, fine aggregates, coarse aggregates, crushed sand and air classified sand.

8. The concrete product as claimed in claim 6, wherein the mix is cured for a period of nine to twenty-eight days to obtain the predefined compressive strength of 25-40 MegaPascal (Mpa).

9. The concrete product as claimed in claim 6, wherein the mix comprises 1-part cement, 1-part shredded redundant tires:5-parts crushed sand.

10. The concrete product as claimed in claim 6, wherein the mix is cured for a period of nine or twenty-eight days.
